(19) United States
(12) Patent Application Publication
(10) Pub. No.: US 2022/0171336 A1
(43) Pub. Date: Jun. 2, 2022

(54) SPIRAL SPRING FOR HOROLOGICAL RESONATOR MECHANISM PROVIDED WITH RIGIDITY-ADJUSTMENT MEANS

(71) Applicant: OMEGA SA, Biel/Bienne (CH)

(72) Inventor: Mohammad Hussein KAHROBAIYAN, Neuchâtel (CH)

(73) Assignee: OMEGA SA, Biel/Bienne (CH)

(21) Appl. No.: 17/526,504

(22) Filed: Nov. 15, 2021

(30) Foreign Application Priority Data
Dec. 2, 2020 (EP) 20211322.1
Oct. 12, 2021 (EP) 21202213.1

(51) Int. Cl. G04B 17/06

(52) U.S. Cl. CPC G04B 17/063

(57) ABSTRACT

A spiral spring, in particular for a horological resonator mechanism, the spiral spring (30) extending substantially in a plane, the spiral spring (30) including a flexible strip (2) coiled on itself in a plurality of turns, the strip (2) having a predefined rigidity, the spiral spring (30) including means for adjusting its rigidity, wherein the adjustment means comprise a flexible element (5) in direct contact with the strip (2), the flexible element (5) preferably having a rigidity greater than that of the strip (2), the adjustment means including prestressing means (6) for applying a variable force or torque to the flexible element (5) so as to vary the rigidity of the flexible element (5).

### CROSS-REFERENCE TO RELATED APPLICATIONS

This application claims priority to European Patent Application No. 20211322.1 filed Dec. 2, 2020 and European Patent Application No. 21202213.1 filed Oct. 12, 2021, the entire contents of which are incorporated herein by reference.

### TECHNICAL FIELD OF THE INVENTION

The invention relates to a spiral spring for a horological resonator mechanism, the spiral spring being provided with means for adjusting the rigidity of said spiral spring. The invention also relates to a horological resonator mechanism provided with such a spiral spring.

### TECHNOLOGICAL BACKGROUND

The majority of current mechanical watches are provided with a balance spring and an escapement mechanism of the Swiss pallets type. The balance spring constitutes the time base of the watch. It is also referred to as a resonator.

As for the escapement, this fulfils two main functions:
maintaining the reciprocation of the resonator;
counting these reciprocations.

To form a mechanical resonator, an inertial element, a guide and an elastic return element are necessary. Traditionally, a spiral spring fulfils the role of elastic return element for the inertial element that constitutes a balance. This balance is rotationally guided by pivots that turn in ruby plain bearings.

The balance spiral spring must generally be able to be adjusted to improve the precision of a watch. For this purpose, means for adjusting the rigidity of the spiral spring are used, such as an index for modifying the effective length of the spring. Thus its rigidity is modified to adjust the precision of running of the watch. However, the effect of a traditional index for adjusting the running remains limited, and it is not always effective for making the adjustment sufficiently precise, of the order of a few seconds or a few tens of seconds per day.

For finer adjustment of the running, there exist adjustment means comprising one or more screws arranged in the felloe of the balance. By acting on the screws, the inertia of the balance is modified, which has the effect of modifying the running thereof.

However, this adjustment method is not easy to implement, and even so does not make it possible to obtain sufficient fineness of adjustment of the running of the oscillator.

### SUMMARY OF THE INVENTION

The aim of the present invention is to overcome all or some of the drawbacks mentioned previously by proposing a spiral spring provided with effective and precise adjustment means, configured in particular to adjust the running of a timepiece by modifying the effective length of said spiral.

For this purpose, the invention relates to a spiral spring for a horological resonator mechanism, the spiral spring comprising a flexible strip coiled on itself in a plurality of turns, the strip having a predefined rigidity, the spiral spring including means for adjusting the rigidity thereof.

The invention is remarkable in that the adjustment means include a flexible element arranged in series with the strip, the flexible element connecting one end of said strip to a fixed support, so as to add additional rigidity to the strip, the flexible element preferably having a rigidity greater than that of the strip, the adjustment means including prestressing means for applying a variable force or torque to the flexible element without modifying the position of the end of the strip, so as to vary solely the rigidity of the flexible element.

By virtue of the invention, by acting on the prestressing means, the force or the torque applied to the flexible element is modified, which causes a modification of the rigidity of the assembly comprising the flexible element and the strip. This is because the flexible element put in series with the strip provides additional rigidity for the strip, which is added to that of the strip. Thus, when the prestressing means apply a variable force or torque to the flexible element, they modify the rigidity of the flexible element and therefore of the assembly comprising the strip without modifying the rigidity of the strip, the end of which keeps the same position, whatever the variable force or torque applied to the flexible element.

In other words, the flexible element is put in series with the strip between one end of the strip and the fixed support. This flexible element provides additional flexibility to the resonator. Thus, the effective flexibility of the resonator comprises the flexibility of the strip and the flexibility of the flexible element. Then a variable force or torque is applied for prestressing the flexible element without prestressing the strip and without moving the end of the strip. By prestressing the flexible element, the flexibility thereof changes, while the flexibility of the strip remains unchanged, since it is not prestressing and the end thereof does not move. By changing the flexibility of the flexible element, the flexibility of the resonator (the flexibility of the strip and the flexibility of the flexible element) changes, which consequently modifies the running of the resonator. Since the flexible element is preferably more rigid than the strip, the share of the flexibility of the flexible element in the overall flexibility is smaller than that of the strip. Consequently, modifying the flexibility of the flexible element modifies the flexibility of the whole of the resonator, and consequently adjusts the running thereof finely, which makes it possible to precisely adjust the frequency of our time base. In this way great precision in the adjustment of the running is obtained, since the action is on a single element for adjusting the rigidity.

According to a particular embodiment of the invention, the flexible element is arranged at an external end of the strip.

According to a particular embodiment of the invention, the flexible element is arranged at an internal end of the strip.

According to a particular embodiment of the invention, the flexible element comprises a flexible neck.

According to a particular embodiment of the invention, the flexible element includes a translation table provided with two substantially parallel flexible blades and a movable rigid part to which the strip is connected.

According to a particular embodiment of the invention, the flexible element comprises a flexible guide provided with two crossed blades and a movable rigid part to which the strip is connected.

According to a particular embodiment of the invention, the flexible element comprises a flexible guide provided with two uncrossed blades and a movable rigid part to which the strip is connected.

According to a particular embodiment of the invention, the flexible element comprises a flexible ring to which the strip is connected.

According to a particular embodiment of the invention, the flexible element comprises a flexible arm to which the strip is connected.

According to a particular embodiment of the invention, the flexible element comprises a plurality of rigid portions connected by flexible blades or necks.

According to a particular embodiment of the invention, the flexible element comprises a flexible blade.

According to a particular embodiment of the invention, the torque or force is adjustable continuously by the prestressing means.

According to a particular embodiment of the invention, the prestressing means comprise a screw configured to come into adjustment against the flexible element.

According to a particular embodiment of the invention, the prestressing means comprise a first magnet secured to the flexible element and a second magnet able to move with respect to the first magnet.

According to a particular embodiment of the invention, the prestressing means comprise a spring and a movable element making it possible to stretch or compress the spring.

According to a particular embodiment of the invention, the spring comprises a plurality of substantially parallel flexible blades and another movable element.

According to a particular embodiment of the invention, the prestressing means comprise a secondary flexible blade connected to the flexible element.

According to a particular embodiment of the invention, the prestressing means comprise a lever.

According to a particular embodiment of the invention, the flexible element arranged in series in line with the strip.

According to a particular embodiment of the invention, the spiral spring lies substantially in a plane.

According to a particular embodiment of the invention, the whole strip is used for the effective rigidity of the spiral spring.

According to a particular embodiment of the invention, no part of the strip is fixed during oscillating.

According to a particular embodiment of the invention, the adjustment means can be actuated when the spiral spring is mounted on a disc of a horological movement.

The invention also relates to a rotary resonator mechanism, in particular for a horological movement, including an oscillating mass and such a spiral spring.

### BRIEF DESCRIPTION OF THE FIGURES

The aims, advantages and features of the present invention will emerge from the reading of a plurality of embodiments given solely by way of non-limitative examples, with reference to the accompanying drawings, in which:

FIG. 1 shows schematically a plan view of a flexible guide according to a first embodiment of the invention,

FIG. 2 shows schematically a plan view of a flexible guide according to a second embodiment of the invention,

FIG. 3 shows schematically a plan view of a flexible guide according to a third embodiment of the invention,

FIG. 4 shows schematically a plan view of a flexible guide according to a fourth embodiment of the invention,

FIG. 5 shows schematically a plan view of a flexible guide according to a fifth embodiment of the invention,

FIG. 6 shows schematically a plan view of a flexible guide according to a sixth embodiment of the invention,

FIG. 7 shows schematically a plan view of a flexible guide according to a seventh embodiment of the invention,

FIG. 8 shows schematically a plan view of a flexible guide according to an eighth embodiment of the invention,

FIG. 9 shows schematically a plan view of a flexible guide according to a ninth embodiment of the invention,

FIG. 10 shows schematically a plan view of a flexible guide according to a tenth embodiment of the invention,

FIG. 11 shows schematically a plan view of a flexible guide according to an eleventh embodiment of the invention,

FIG. 12 shows schematically a plan view of a flexible guide according to a twelfth embodiment of the invention,

FIG. 13 shows schematically a plan view of a flexible guide according to a thirteenth embodiment of the invention,

FIG. 14 shows schematically a plan view of a flexible guide according to a fourteenth embodiment of the invention,

FIG. 15 shows schematically a plan view of a flexible guide according to a fifteenth embodiment of the invention,

FIG. 16 shows schematically a plan view of a flexible guide according to a sixteenth embodiment of the invention,

FIG. 17 shows schematically a plan view of a flexible guide according to a seventeenth embodiment of the invention,

FIG. 18 shows schematically a plan view of a flexible guide according to an eighteenth embodiment of the invention,

FIG. 19 shows schematically a plan view of a flexible guide according to a nineteenth embodiment of the invention,

FIG. 20 shows schematically a plan view of a flexible guide according to a twentieth embodiment of the invention,

FIG. 21 shows schematically a plan view of a flexible guide according to a twenty-first embodiment of the invention, and

FIG. 22 shows schematically a plan view of a flexible guide according to a twenty-second embodiment of the invention,

FIG. 23 shows schematically a plan view of a flexible guide according to a twenty-third embodiment of the invention,

FIG. 24 shows schematically a plan view of a flexible guide according to a twenty-fourth embodiment of the invention,

FIG. 25 shows schematically a plan view of a flexible guide according to a twenty-fifth embodiment of the invention,

FIG. 26 shows schematically a plan view of a flexible guide according to a twenty-sixth embodiment of the invention,

FIG. 27 shows schematically a plan view of a flexible guide according to a twenty-seventh embodiment of the invention,

FIG. 28 shows schematically a plan view of a flexible guide according to a twenty-eighth embodiment of the invention,

FIG. 29 shows schematically a plan view of a flexible guide according to a twenty-ninth embodiment of the invention.

### DETAILED DESCRIPTION OF THE INVENTION

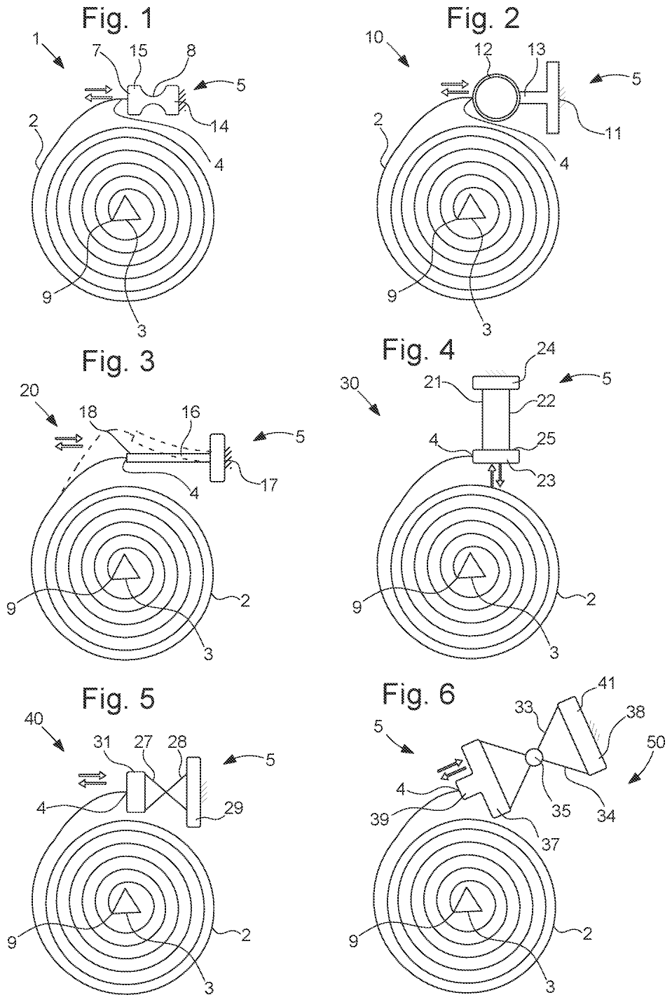

FIGS. 1 to 28 each show a schematic representation of a different embodiment of a spiral spring 1, 10, 20, 30, 40, 50, 60, 70, 80, 90, 100, 110, 120, 130, 140, 150, 160, 170, 180, 190, 200, 210, 220, 230, 240, 250, 260, 270, in particular for a horological resonator mechanism. Here, the spiral spring lies substantially in a plane. The spiral spring 1, 10, 20, 30, 40, 50, 60, 70, 80, 90, 100, 110, 120, 130, 140, 150, 160, 170, 180, 190, 200, 210, 220, 230, 240, 250, 260, 270 comprises a flexible strip 2 coiled on itself in a plurality of turns, the strip 2 having a predefined rigidity. The spiral spring includes means for adjusting the rigidity thereof. For example, the adjustment means can in particular be actuated when the spiral spring is mounted on a disc of a horological movement.

According to the invention, the adjustment means comprise a flexible element 5 arranged in series in line with the strip 2, the flexible element 5 connecting one end 4, 9 of said strip 2 to a fixed support 11, 14, 17, 24, 29, 38, 44, 53, 93, 117, and secured to one of the ends 4, 9 of the strip 2. The flexible element 5 adds additional rigidity to that of the strip 2. The flexible element 5 preferably has a rigidity greater than that of the strip 2. Here, the flexible element 5 is arranged in line with the strip 2. The adjustment means 5 and the strip 2 are preferably in a single piece, or even formed from the same material.

The spiral spring 1, 10, 20, 30, 40, 50, 60, 70, 80, 90, 100, 110, 120, 130, 140, 150, 160, 170, 180, 190, 200, 210, 220, 230, 240, 250, 260, 270 furthermore includes prestressing means 6 for applying a variable force or torque to the flexible element 5. Thus it is possible to adjust the rigidity of the spiral spring 1, 10, 20, 30, 40, 50, 60, 70, 80, 90, 100, 110, 120, 130, 140, 150, 160, 170, 180, 190, 200, 210, 220, 230, 240, 250, 260, 270, in particular for improving the precision of the running of the movement.

The end of the strip 2 remains substantially immobile, whatever the adjustment of the prestressing means. The force or torque applied to the flexible element 5 does not modify the position of the end 4 of the strip 2 to which the flexible element is connected. The action is solely on the flexible element 5 for modifying the rigidity thereof without acting directly on the strip 2. In this way even greater precision is obtained since a single element serves for adjusting the rigidity.

In addition, the torque or force is adjustable continuously by the prestressing means 6. In other words, the torque or force is not restricted to values at a singular point. Thus it is possible to adjust the rigidity of the flexible element 5 with great precision.

The prestressing means 6 preferably enable the flexible element 5 to make a translation or rotation movement in the plane of the spiral spring. Thus the rigidity of the flexible element 5 is varied.

The embodiments described below comprise a flexible element 5 secured to the external end 4 of the strip 2. The internal end 9 of the strip 2 is connected to a support 3 of an oscillating mass of the resonator. According to variant embodiments, not shown on the figures, the flexible element is connected to the internal end 9 of the strip 2, in order to be in series between the strip 2 and the support 3 of the oscillating mass.

In the example of FIG. 1, the flexible element 5 of the spiral spring 1 comprises an elongate body 7 provided with a neck 8 thinned in the thickness of material, the neck being flexible. Thus the flexible element 5 includes a fixed support 14, for example attached to the disc of the movement, and a movable part 15 attached to the external end 4 of the strip 2, the fixed support 14 and the movable part 14 being connected by the neck 8. By applying a variable force or torque to the movable part 15, it moves with respect to the fixed support 14. Thus the rigidity of the flexible element 5e and therefore of the assembly comprising the strip 2 and the flexible element 5 is modified.

The second embodiment of the spiral spring 10 of FIG. 2 shows a flexible element 5 comprising a flexible ring 12 joined to the external end 4 of the strip 2. The flexible element 5 also comprises a T-shaped fixed support 11, which is immobile with respect to the movement. The ring 12 is furthermore connected to the base 13 of the T. Thus, by applying a variable force or torque to the ring 12, it deforms with respect to the fixed support 11, so that the rigidity of the flexible element 5 is modified.

For the third embodiment of the spiral spring 20 of FIG. 3, the flexible element 5 of the spiral spring comprises a flexible arm 16 and a fixed support 17 to which the arm 16 is joined in cantilever. The external end 4 of the strip 2 is joined to the end 18 of the arm 16 in line therewith. Thus, by applying a variable force or torque to the arm 16, it deforms with respect to the fixed support 17, so as to modify the rigidity of the flexible element 5. On the figure, the variable force or torque is preferably applied parallel to the arm 16.

FIG. 4 shows a spiral spring 30 the flexible element 5 of which includes a translation table. The translation table comprises at least one secondary flexible blade, here two secondary flexible blades 21, 22, and a rigid part 23. The flexible blades 21, 22 are joined by one end to the rigid part 23, and by another end to a fixed support 24. The secondary flexible blades 21, 22 are substantially parallel and are disposed on different lines. Preferably, the secondary flexible blades 21, 22 are joined to one and the same face 25 of the rigid part 23. The rigid part 23 has an elongate rectangular form, to which the external end 4 of the strip 2 is attached in line therewith on one side of the rigid part 23. The secondary flexible blades 21, 22 are substantially perpendicular to the rigid part 23 and to the external end 4. On the figure, the variable force or torque is applied to the rigid part 23, preferably parallel to the blades 21, 22.

On FIG. 5, the flexible element 5 of the spiral spring 40 comprises a pivot with crossed blades, the pivot comprising two crossed blades 27, 28, connected firstly to a fixed support 29 of the movement and secondly to a movable rigid part 31 of the pivot. The rigid part 31 has an elongate rectangular form arranged perpendicular to the external end 4 of the strip 2, which is connected to a large side of the rigid part 31, opposite to the side to which the crossed blades 27, 28 are connected. The pivot with crossed blades 27, 28 is arranged so that the crossing of the blades is in line with the external end 4 of the strip 2. On the figure, the variable force or torque is applied to the rigid part 31, preferably parallel to the axis of symmetry of the crossed-blades pivot and to the external end 4 of the strip 2.

In the sixth embodiment in FIG. 6, which is similar to the fifth embodiment, the flexible element 5 of the spiral spring 50 comprises a crossed-blades pivot, the pivot comprising two crossed blades 33, 34 joined at their crossing 35. The blades 33, 34 are connected firstly to a fixed support 38 of the movement and secondly to a T-shaped rigid part 37. The stem 39 of the T is joined to the external end 4 of the strip, while the blades are joined to the bar 41 of the T. The crossed-blades pivot is arranged so that the crossing of the blades is in line with the external end 4 of the strip 2. On the figure, the variable force or torque is applied to the bar 37 of the T of the rigid part 37, the pivot being arranged obliquely with respect to the strip 2.

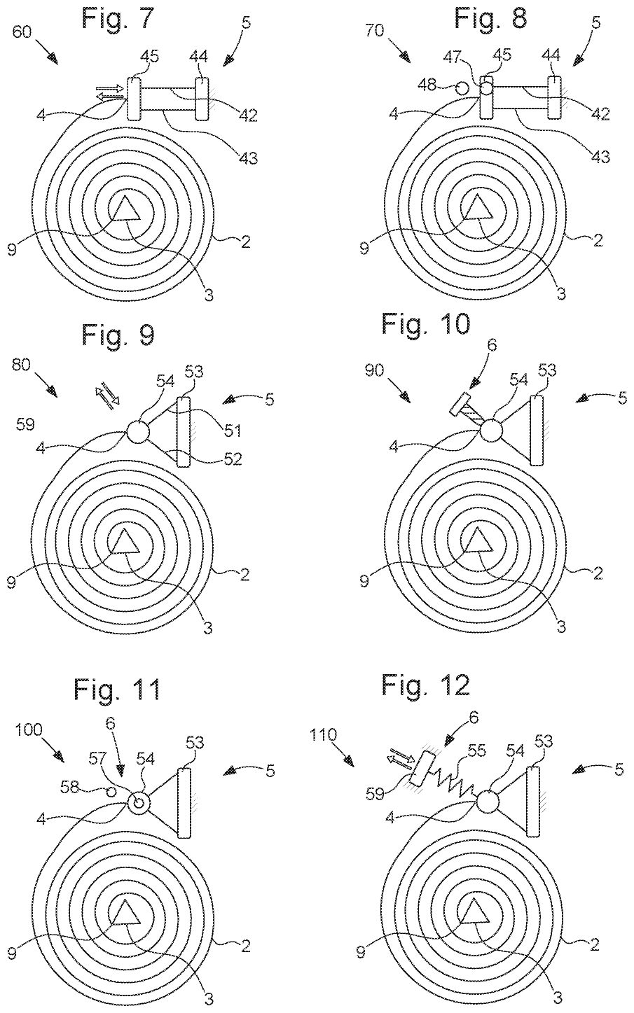

For the seventh embodiment in FIG. 7, the flexible element 5 of the spiral spring 60 comprises a translation table arranged in line with the external end 4 of the strip 2. The translation table comprises at least one secondary flexible blade, here two secondary flexible blades 42, 43, and a rigid part 45. The secondary flexible blades 42, 43 are joined by one end to the rigid part 45 and by another end to a support 44 fixed with respect to the movement. The secondary flexible blades 42, 43 are substantially parallel and are disposed on different lines. Preferably, the secondary flexible blades 42, 43 are joined to one and the same face of the rigid part 45. The rigid part 45 has an elongate rectangular shape, to which the external end 4 of the strip 2 is joined perpendicularly in cantilever. The secondary flexible blades 42, 43 are substantially parallel to the external end 4 and perpendicular to the rigid part 45. On the figure, the variable force or torque is applied to the rigid part 45, in the direction of the secondary blades 42, 43. By virtue of the flexing of the secondary flexible parts 42, 43, the rigid part 45 can move parallel to the fixed support 44. By pulling the external end 4 of the strip 2 the movement of the rigid part 45 varies the rigidity of the flexible element 5.

The eighth embodiment of the spiral spring 70 in FIG. 8 comprises a flexible element 5 identical to that of the seventh embodiment in FIG. 7. The spiral spring furthermore comprises means 6 for prestressing the flexible element 5. The prestressing means 6 comprise magnets 47, 48, a first magnet 47 being arranged on the rigid part 45 of the translation table, and a second magnet 48 being arranged so as to be able to move with respect to the first magnet 47. Thus the magnets 47, 48 attract or repel each other according to the polarities thereof, so that a force is applied to the rigid part 45. The second magnet 48 is for example arranged on an element able to move with respect to the translation table.

In the ninth embodiment in FIG. 9, the flexible element 5 of the spiral spring comprises a pivot with uncrossed flexible blades. The pivot comprises two uncrossed flexible blades 51, 52 and a rigid part 54. The flexible blades 51, 52 are joined firstly laterally to an elongate fixed support 53 and secondly to the rigid part 54 while moving closer to each other. The rigid part 54 has a circular shape with a smaller diameter than the fixed support 53. Thus, preferably, the flexible blades 51, 52 move closer to each other from the fixed support 53 as far as the rigid part 54. The external end 4 of the strip is joined to the rigid part 54. On the figure, the variable force or torque is applied to the rigid part 45, obliquely with respect to the pivot. The force is preferably parallel to the axis of symmetry of the flexible-blade pivot.

FIGS. 10 to 20 are embodiments of spiral springs 90, 100, 110, 120, 130, 140, 150, 160, 170, 180, 190 comprising a flexible element 5 identical to that of the ninth embodiment, but each having different prestressing means 6. These prestressing means 6 are of course adaptable to other embodiments of spiral springs with flexible elements 5 different from that of the ninth embodiment.

The tenth embodiment in FIG. 10 comprises a screw 55 as prestressing means 6. The screw 55 is positioned obliquely against the rigid part 54 of the pivot, preferably parallel to the axis of symmetry of the pivot. Thus, by actuating the screw by screwing or unscrewing, the latter applies a variable force or torque to the rigid part 54, in particular in order to adjust the rigidity of the flexible element 5.

On FIG. 11, the prestressing means 6 comprise magnets 57, 58, a first magnet 57 being arranged on the rigid part 54, while a second magnet 58 is able to move with respect to the rigid part 54, in order to exert a variable force or torque on the rigid part 54. The variable force or torque is exerted obliquely on the rigid part 54 in order to adjust the rigidity of the flexible element 5.

The prestressing means 6 of the twelfth embodiment in FIG. 12 comprise a spring 55 and a movable element 59. The spring 55 is joined to the rigid part 54 of the pivot on the one hand and to the movable element 59 on the other hand. Thus, by moving the movable element 59, the spring applies a variable force or torque to the rigid part 54 in order to adjust the rigidity of the flexible element 5.

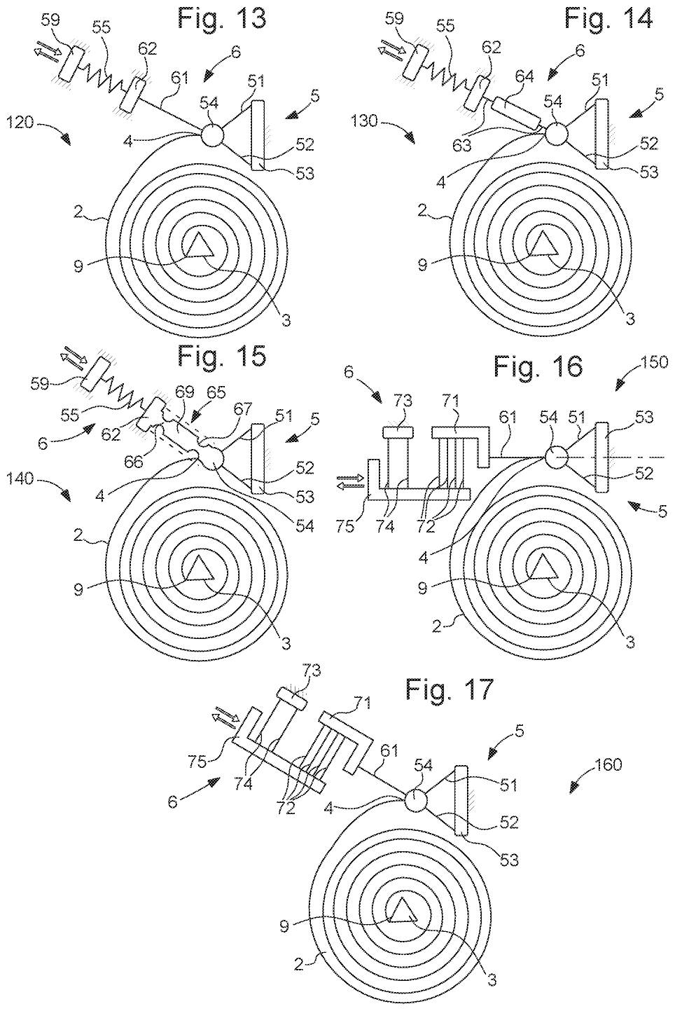

The thirteenth embodiment in FIG. 13 shows a variant of the embodiment of the spiral spring 110 in FIG. 12, in which a secondary flexible blade 61 is arranged in series in line with the spring 55 between the rigid part of the pivot and the spring 55. For this purpose, the prestressing means 6 are provided with a second movable element 62 to which the spring 55 on the one hand and the secondary flexible blade 61 on the other hand are connected. The secondary flexible blade 61 is connected to the second movable element 62 and to the rigid part 54. By acting on the first movable element 59, the variable force or torque acting on the rigid parts of the pivot by means of the second movable element 62 and the secondary flexible blade 61 is modified.

On FIG. 14, the spiral spring 130 is similar to the one in FIG. 13, the spiral spring 130 comprising prestressing means 6 provided with a secondary flexible blade 63 with a rigid portion 64 at the middle of the secondary flexible blade 63.

In the fifteenth embodiment of the spiral spring 140 in FIG. 15, which is similar to the one in FIG. 14, the prestressing means 6 comprise, instead of the secondary flexible blade of the previous two embodiments, an elongate piece 65 provided with at least one flexible neck, here two flexible necks 66, 67. The piece 65 includes a rigid central portion 69 and a flexible neck 66, 67 at each end, one neck being connected to the rigid part 54, the other neck being connected to the movable element 62. The elongate piece 65 is disposed in line with the spring 55.

The sixteenth and seventeenth embodiments in FIGS. 16 and 17 show the same prestressing means 6 oriented differently on the two figures. The prestressing means 6 include a spring formed by flexible blades. A secondary flexible blade 61 connects the rigid part of the flexible element 5 to a first rigid body 71 in the form of an elbow.

The prestressing means 6 comprise a second rigid body 75 in the form of an elbow, as well as tertiary blades 72 connecting the two rigid bodies 71, 75. The two rigid bodies 71, 75 are movable and have segments that are substantially parallel two by two in the idle position of the prestressing means 6. The fourth tertiary blades 72 are substantially perpendicular to the secondary blade 61 in the idle position of the prestressing means 6. The prestressing means 6 furthermore comprise two quaternary blades 74 connecting the second body 75 to a fixed support 73. The quaternary blades 74 are substantially parallel to the tertiary blades 72 and are arranged on the same side of the second rigid body 75. By applying a variable force or torque to the second rigid body 75, the rigidity of the flexible element 5 is varied.

On FIG. 16, the prestressing means 6 are arranged in the axis of the flexible element 5, while on FIG. 17 the prestressing means 6 are arranged obliquely with respect to the flexible element 5.

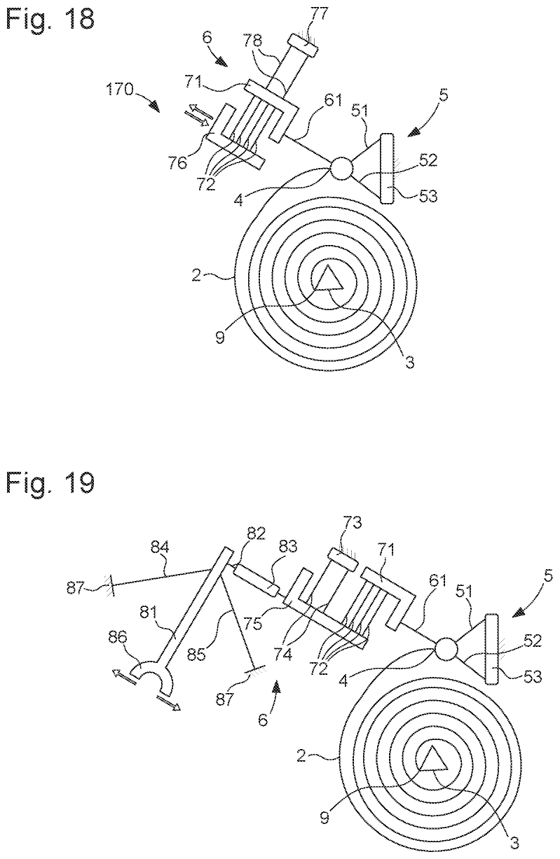

The eighteenth embodiment in FIG. 18 of the spiral spring 170 is similar to that of the seventeenth embodiment, except with regard to the support 77, which is connected to the first movable body 71 by the quaternary blades 78 rather than to the second movable body 76. The support 77 and the quaternary blades 78 are arranged on the other side of the first movable body 71 with respect to the second movable body 76 and the tertiary blades 72. The quaternary blades 78 are substantially parallel to the tertiary blades 72 in the idle position of the spiral spring 170.

FIG. 19 shows prestressing means 6 similar to those in FIG. 17, to which a lever 81 has been added. The lever 81 is connected to the second movable body 75 by a quinquenary flexible blade 82 provided with a rigid central portion 83 arranged in line with the second movable body 75. The quinquenary flexible blade 82 is substantially parallel to the secondary blade 61 in the idle position of the prestressing means 6. The lever 81 is arranged perpendicularly to the quinquenary flexible blade 82. The lever is furthermore connected to a second fixed support 87 by two quinquenary blades 84, 85 arranged on either side of the lever 81. The free end 86 of the lever is in a U shape, on which it is possible to act by actuating it laterally, in order to apply a variable force or torque to the flexible element 5.

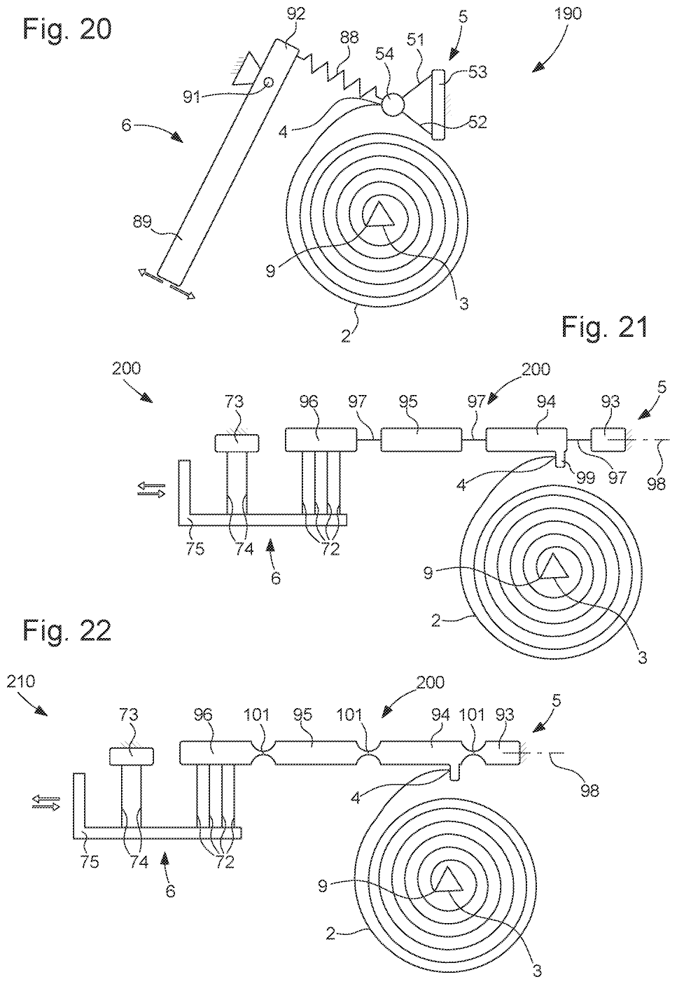

On FIG. 20, the prestressing means 6 comprise a lever 89 connected to the flexible element 5 by a spring 88, which may be helical or formed by a flat coil. The spring is connected to the rigid part 54 of the flexible element 5 on the one hand, and to the lever 89 on the other hand. The lever 89 can pivot about a fixed spindle 91 passing through it at the end 92 connected to the spring. Thus, by moving the lever 89 laterally, the variable torque or the force exerted on the flexible element 5 is modified.

The twenty-first embodiment of the spiral spring 200 in FIG. 21 comprises a flexible element 5 provided with a plurality of movable rigid portions 93, 94, 95, 96 joined by small flexible blades 97. In the idle position the portions 93, 94, 95, 96 and the small flexible blades 97 are arranged substantially on a straight line 98. On the figure, the flexible element 5 comprises four elongate portions 93, 94, 95, 96 in series and three small blades 97 each connecting two portions 93, 94, 95, 96 together. The first portion 93 is a fixed support, while the other portions 94, 95, 96 are movable. The external end 4 of the strip 2 is joined to the second portion 94, the second portion 94 including a lateral lug 99 to which the strip 2 is connected. The portions 93, 94, 95, 96 and the small blades 97 extend tangentially to the spiral form of the strip 2.

The prestressing means 6 also comprise a rigid body 75 in the form of an elbow, as well as secondary blades 72 connecting the rigid body 75 to the fourth portion 96. The four secondary blades 72 are substantially perpendicular to the straight line 98 in the idle position of the prestressing means 6. The prestressing means 6 further comprise two tertiary blades 74 connecting the rigid body 75 to a fixed support 73. The tertiary blades 74 are substantially parallel to the secondary blades 72 in the idle position of the prestressing means 6. By applying a variable force or torque to the elbowed part of the rigid body 75, the rigidity of the flexible element 5 is varied. The force or torque is transmitted partly to the fourth portion 96 by the secondary blades 72, as well as to the other portions via the small blades 97.

In the twenty-second embodiment in FIG. 22, the spiral spring 210 is substantially the same as the one in FIG. 21, the rigid portions 93, 94, 95, 96 being connected by flexible necks 101 in place of the small blades 97 in FIG. 21. A neck 101 is an element of thinned material, which is flexible.

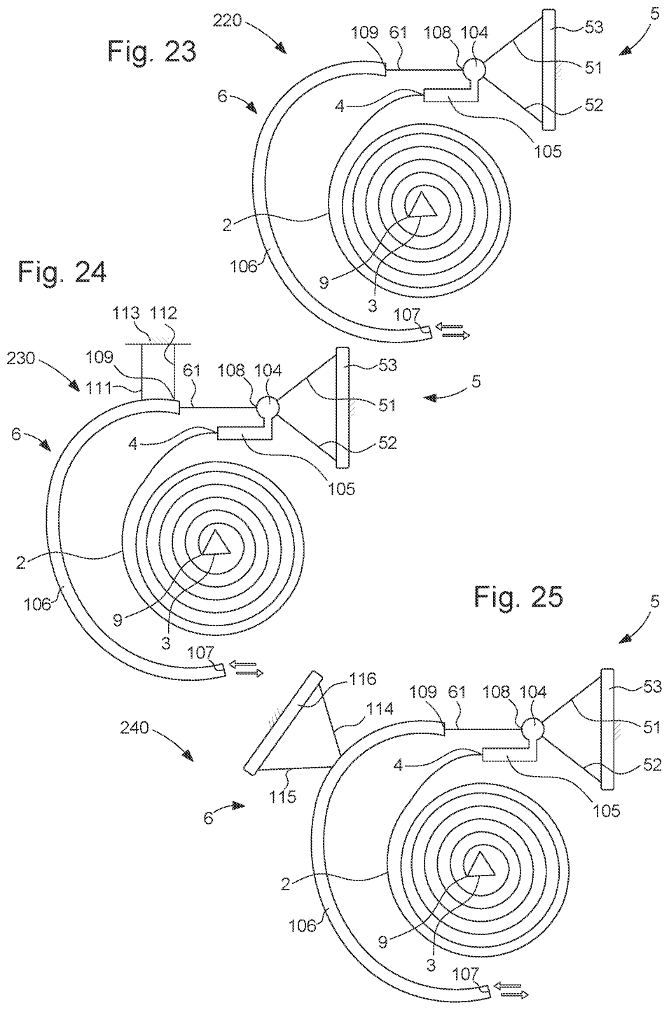

The embodiments in FIGS. 23 to 25 of the spiral spring 220, 230, 240 each comprise a flexible element 5 such as the one in FIGS. 9 to 20, i.e. a pivot provided with two uncrossed flexible blades 51, 52 and a rigid part 104. The rigid part 104 also comprises a lug 105 disposed as a right-angled bracket alongside the strip 2, and to which the finishing part 4 of the strip 2 is joined. The prestressing means 6 comprise a secondary flexible blade 61 joined at one end 108 to the circular part of the rigid part 104, preferably in the axis of symmetry of the pivot. The secondary flexible blade 61 extends tangentially to the coiled strip 2 in the idle position of the spiral spring. The prestressing means 6 furthermore comprise a lever 106 joined to the opposite end 109 of the secondary blade 61. The lever 106 is preferably curved to pass round the coiled strip 2. The force or torque is applied to its free end 107 parallel to the secondary blade 61. Thus the force or torque is transmitted partly to the rigid part 104 through the secondary flexible blade 61.

In the embodiment in FIG. 24, which repeats the features of the embodiment in FIG. 23, the prestressing means 6 of the spiral spring 220 also comprise two substantially parallel tertiary blades 111, 112. The tertiary blades 111, 112 are joined on the one hand to the lever 106, at the connection to the secondary blade 61. The tertiary blades 111, 112 are connected on the other hand to a fixed support 113 and are substantially perpendicular to the secondary blade 61.

The spiral spring 240 of FIG. 25, which repeats the features of the embodiment in FIG. 23, furthermore describes prestressing means 6 provided with uncrossed tertiary blades 114, 115, which are joined to a fixed support 116 on the one hand, and to the lever 106 on the other hand. The tertiary blades 114, 115 approach each other as they go towards the lever 106 and are disposed in the curvature of the lever 106, being further away from the connection with the secondary blade 61.

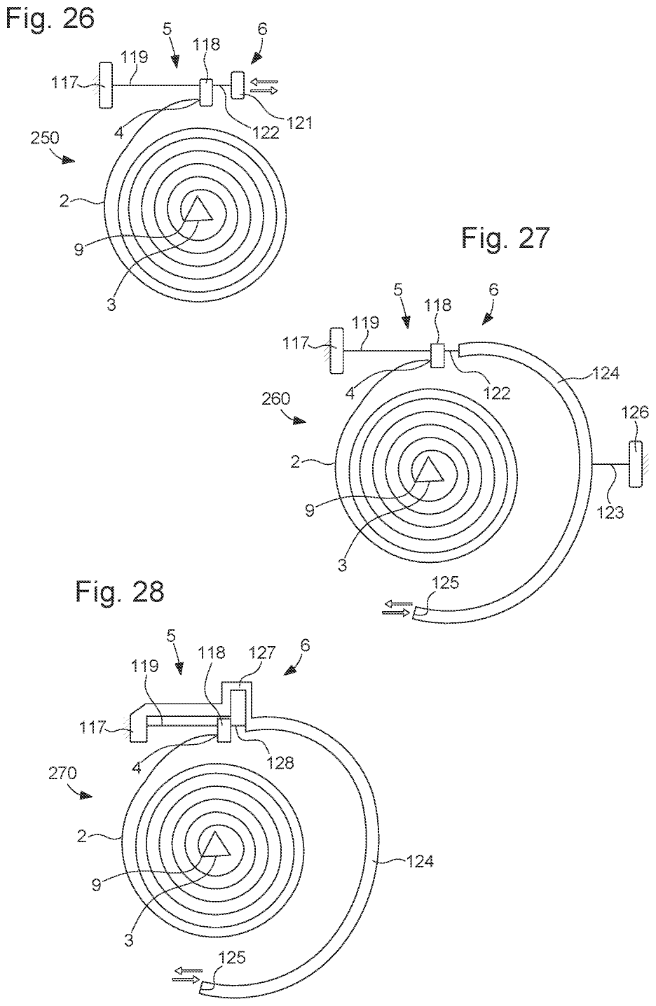

The embodiments of the spiral spring 250, 260, 270 in FIGS. 26 to 28 describe a flexible element 5 including a first flexible blade 119 and a movable rigid part 118, here rectangular, connected to the first flexible blade 119 and to the external end 4 of the strip 2, preferably on the same side as the rigid part 118. The first flexible blade 119 is connected moreover to a fixed support 117. The prestressing means 6 include a shorter secondary flexible blade 122, 128 arranged on an opposite face of the rigid part 118 in the axis of the first flexible blade 119. The first flexible blade 119 and the secondary flexible blade 122, 128 are disposed tangentially to the strip 2.

On FIG. 26, the secondary flexible blade 122 is connected to a second rigid part 121 of the prestressing means 6. The force or torque is exerted on the second rigid part 121 in the direction of the first 119 and secondary 122 flexible blades.

In the embodiment in FIG. 27, the secondary flexible blade 122 is connected to a curved lever 124 passing round the coiled strip 2. A tertiary flexible blade 123 connects the lever 124 to a fixed support 126, in the curvature of the lever 124. The force or torque is exerted on the free end 125 of the lever 124, preferably parallel to the first 119 and secondary 122 flexible blades. The force or torque is partly transmitted to the secondary flexible blade 122, and to the first flexible blade 119.

FIG. 28 shows an embodiment wherein the secondary flexible blade 128 is connected by the other end to a curved lever 124 passing round the coiled strip 2. The lever 124 is connected, in addition to the elbowed blade 128, to a semi-rigid structure 127 connected to the fixed support 117. The semi-rigid structure 127 partly deforms when the lever 124 is actuated by the force or torque. The force or torque is exerted on the free end 125 of the lever.

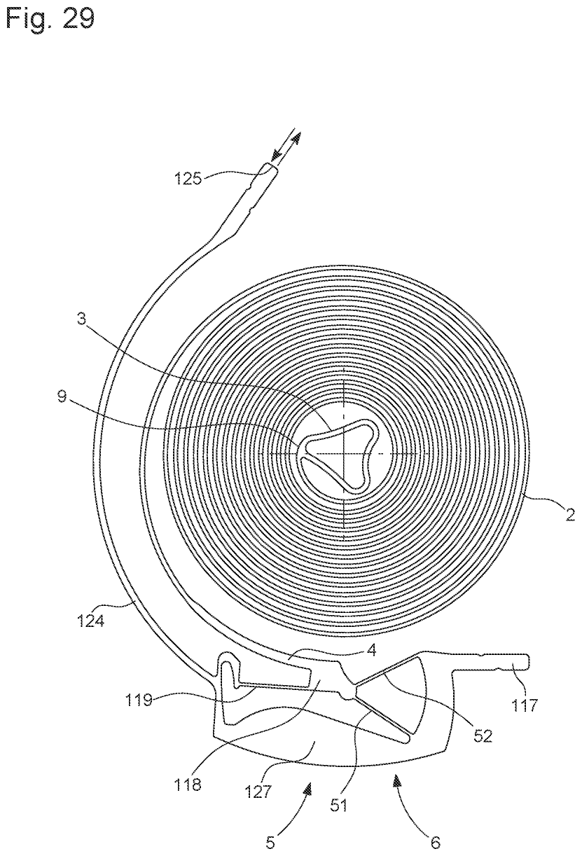

The last embodiment in FIG. 29 is similar to the one in FIG. 28, the first flexible blade being replaced by a pivot with uncrossed flexible blades, as described in the embodiments in FIGS. 9 to 20. The pivot comprises two blades 51, 52 separating from the rigid part 118 as far as the fixed support 117.

The flexible blades described in the various embodiments of the spiral spring may be continuous flexible blades, as is generally the case in the figures, or flexible blades with rigid portions and flexible necks connecting the portions.

The invention also relates to a rotary resonator mechanism, in particular for a horological movement. The resonator mechanism includes an oscillating mass, not shown in the figures, and a spiral spring as described previously. The oscillating mass is for example an annular balance. The oscillating mass is joined to the spiral spring so as to be secured to the support 3.

1. A spiral spring, in particular for a horological resonator mechanism, the spiral spring comprising a flexible strip coiled on itself in a plurality of turns, the strip having a predefined rigidity, the spiral spring including means for adjusting the rigidity thereof, wherein the adjustment means include a flexible element arranged in series with the strip, the flexible element connecting one end of said strip to a fixed support, so as to add an additional rigidity to the strip, the flexible element preferably having a rigidity greater than that of the strip, the adjustment means including prestressing means for applying a variable force or torque to the flexible element without modifying the position of the end of the strip, so as to vary solely the rigidity of the flexible element.

2. The spiral spring according to claim 1, wherein the flexible element is arranged at an external end of the strip.

3. The spiral spring according to claim 1, wherein the flexible element is arranged at an internal end of the strip.

4. The spiral spring according to claim 1, wherein the flexible element comprises a flexible neck.

5. The spiral spring according to claim 1, wherein the flexible element includes a translation table provided with two substantially parallel flexible blades and a movable rigid part to which the strip is connected.

6. The spiral spring according to claim 1, wherein the flexible element comprises a flexible guide provided with two crossed blades and a movable rigid part to which the strip is connected.

7. The spiral spring according to claim 1, wherein the flexible element comprises a flexible guide provided with two uncrossed blades and a movable rigid part to which the strip is connected.

8. The spiral spring according to claim 1, wherein the flexible element comprises a flexible ring to which the strip is connected.

9. The spiral spring according to claim 1, wherein the flexible element comprises a flexible arm to which the strip is connected.

10. The spiral spring according to claim 1, wherein the flexible element comprises a plurality of rigid portions connected by blades or flexible necks.

11. The spiral spring according to claim 1, wherein the flexible element comprises a single flexible blade.

12. The spiral spring according to claim 1, wherein the torque or force is adjustable continuously by the prestressing means.

13. The spiral spring according to claim 1, wherein the prestressing means comprise a screw configured to come into abutment against the flexible element.

14. The spiral spring according to claim 1, wherein the prestressing means comprise a first magnet secured to the flexible element and a second magnet movable with respect to the first magnet.

15. The spiral spring according to claim 1, wherein the prestressing means comprise a spring and a movable element for stretching or compressing the spring.

16. The spiral spring according to claim 15, wherein the spring comprises a plurality of substantially parallel flexible blades and another movable element.

17. The spiral spring according to claim 1, wherein the prestressing means comprise a secondary flexible blade connected to the flexible element.

18. The spiral spring according to claim 15, wherein the prestressing means comprise a lever.

19. A rotary resonator mechanism, in particular fora horological movement, including an oscillating mass, wherein it comprises a spiral spring according to claim 1.
